(19) United States
(12) Patent Application Publication
(10) Pub. No.: US 2007/0127027 A1
(43) Pub. Date: Jun. 7, 2007

(54) Photometer having multiple light paths

(76) Inventors: John C. Kralik, Devon, PA (US); Judith A. Thompson, Wilmington, DE (US); Jay K. Bass, Kennett Square, PA (US); Jacqueline M. Tso, Los Gatos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/291,258

(22) Filed: Dec. 1, 2005

(51) Int. Cl. G01N 21/59

(52) U.S. Cl. 356/432

(57) ABSTRACT

A photometer for analyzing a plurality of samples. The photometer comprises a light source and a detector. An optical assembly defines two or more light paths, each light path arranged to carry light from the light source, through a separate sample location, and to the detector.

### BACKGROUND

Spectrophotometry operates on the principle that certain compounds will absorb certain wavelengths (i.e., colors) of light. Light having known intensity at a variety of wavelengths is projected into one side of a sample vessel of known thickness that contains a sample such as a liquid, mixture, solution, reacting mixture, or the like. The light is detected after it exits the other side of the sample vessel. The detected light is analyzed for the absence, or reduced intensity levels, of certain wavelengths of light. This information, along with the sample thickness, is used to identify and measure the concentration of compounds in the sample.

One difficulty with spectrophotometers (i.e., the instrument used for spectrophotometry) is that they have limited throughput because they can analyze a sample in only one vessel at a time. If there are multiple vessels, a user must individually load and test each sample, which can take significant amounts of time, especially if there are a large number of samples that must be analyzed.

### SUMMARY

In general terms the present disclosure and claims relate to a photometer having two or more light paths arranged to carry light to separate sample locations.

One aspect is a photometer for analyzing a plurality of samples. The photometer comprises a light source and a detector. An optical assembly defines two or more light paths, each light path arranged to carry light from the light source, through a separate sample location, and to the detector.

Another aspect is a photometer for analyzing a plurality of samples. The photometer comprises a light source and a two-dimensional photo-detector array (2D-PDA). An optical assembly defines two or more light paths. Each light path includes at least one input optical fiber arranged between the light source and a sample location. A lens is positioned between the input optical fiber and the sample location, and is configured to substantially collimate light radiated from the input optical fiber. At least one output optical fiber is arranged between the sample location and the 2D-PDA. The output optical fiber has a first end positioned to receive light passing through the sample location and a second end positioned to direct light to the 2D-PDA. The second end is positioned to substantially eliminate crosstalk between light directed to the 2D-PDA from the two or more light paths.

Another aspect is a method of analyzing a plurality of samples. The method comprises conducting light along two or more light paths; passing the light from each of the two or more light paths through separate samples; and conducting the light from each of the separate samples to a detector.

### DESCIPTION OF THE DRAWINGS

FIG. 1 is a schematic drawing illustrating one possible embodiment of a spectrophotometer.

FIG. 2 illustrates a possible arrangement of a portion of the optical fibers taken along line 2-2 in FIG. 1.

FIG. 3 is an axiometric view of the spectrometer and a portion of the optical fibers shown in FIG. 1.

FIG. 4 illustrates the detector shown in FIG. 3.

FIG. 5 illustrates sample output from the detector shown in FIGS. 1 and 2.

FIG. 6 illustrates an alternative embodiment of a bracket shown in FIG. 3.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the claimed subject matter.

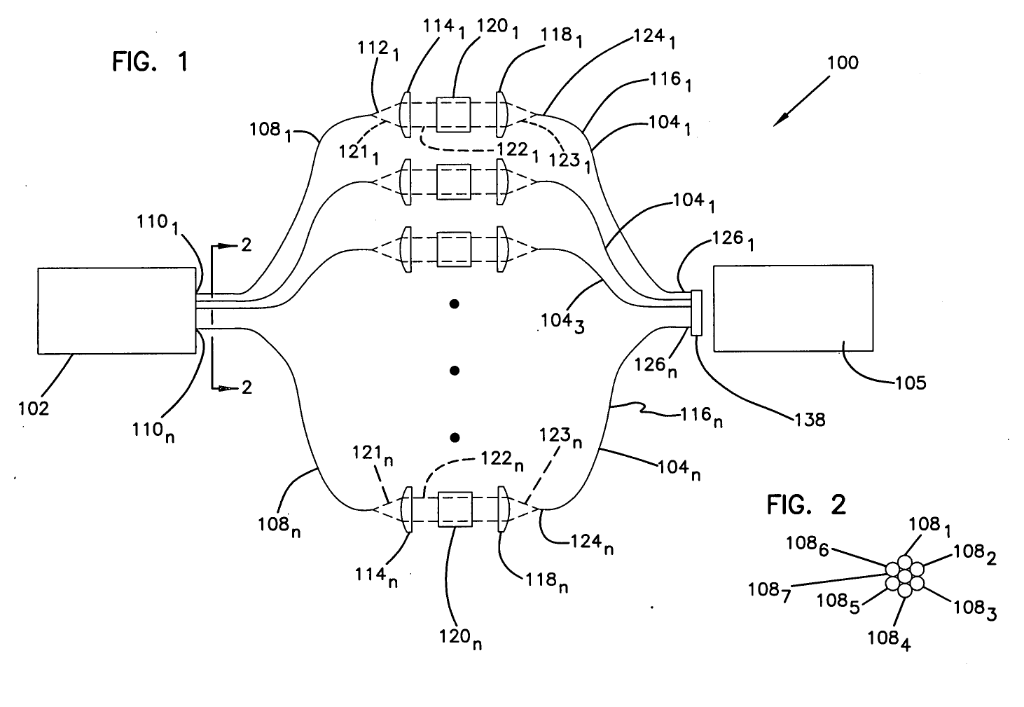

FIG. 1 illustrates a spectrophotometer, generally shown as 100. The spectrophotometer 100 includes a plurality of light paths 104₁-104ₙ that form signal paths or channels and extend between a light source 102 and a spectrometer 105. In the exemplary embodiment, the light paths 104₁-104ₙ are substantially similar to one another, and for purposes of explanation light path 104ₙ is described herein in more detail with the understanding that the reference n could apply to any of the light paths 104₁-104ₙ. Other embodiments, however, might provide different structures for each of the light paths 104₁-104ₙ and different numbers of light paths 104ₙ.

The light path 104ₙ includes an input optical fiber 108ₙ and an output optical fiber 116ₙ. The input optical fiber 108ₙ has first and second ends 110ₙ and 112ₙ extending between the light source 102 and a first optical coupling arrangement 114ₙ, and the output optical fiber 116ₙ has first and second ends 124ₙ and 126ₙ extending between a second optical coupling arrangement 118ₙ and a position proximal to a spectrometer 105.

The light source 102 includes a lamp for generating light and appropriate conventional input optics arranged to couple light from the lamp into the first end 110ₙ of the optical fiber 108ₙ. Additionally, the first ends 110₁-110ₙ of the input optical fibers 108₁-l08ₙ are tightly bundled in the exemplary embodiment as illustrated in FIG. 2 (which illustrates exemplary bundling for seven input optical fibers 108₁-108₇) so that all of the input optical fibers 104₁-104ₙ collect light from the light source 102 for travel along the light paths 104₁-104ₙ.

In the exemplary embodiment, the light source 102 includes a broadband light source such as a Xenon flash lamp providing light in the ultraviolet, visible, and near infrared spectrum or in the range of about 200 to about 1000 nm. Although the exemplary embodiment of the light source 102 is a single lamp with appropriate conventional optics to couple light into the input optical fibers 108₁-108ₙ, alternative embodiments include separate lamps, each separate lamp arranged to direct light into a separate, individual input optical fiber 108₁-108ₙ or into small groups of fibers that are within the main group of input optical fibers 108₁-108ₙ. Additionally, the light source 102 can output light having various ranges of wavelengths other than the exemplary embodiment and also can include other types of devices for generating light such as incandescent lamps, light emitting diodes (LEDs), as well as dual sources such as separate deuterium and tungsten lamps.

The first and second optical coupling arrangements 114ₙ and 118ₙ oppose each other and are spaced to form a sample location 120ₙ in which a sample vessel (not shown) can be positioned between the first and second optical coupling arrangements 114ₙ and 118ₙ. The sample location 120ₙ is sized to receive a sample vessel. Although the first and second optical coupling arrangements 114ₙ and 118ₙ of the exemplary embodiment are arranged to project light through opposite sides of the sample location 120ₙ, other embodiments are possible.

An example of a sample vessel includes cuvettes, capillaries, and standard spectrophotometer cells. A possible embodiment uses sample vessels having a volume of about 5 μl or less. Another possible embodiment utilizes sample vessels having a volume of about 2 μl or less, and yet another possible embodiment utilizes sample vessels having a volume of about 1 μl or less. Other embodiments utilize sample vessels having different volumes as well. Still other embodiments simultaneously utilize sample vessels of different volumes. For example, during use of the spectrophotometer 100 a sample vessel of a first volume might be in sample location 120₁, while a sample vessel of a second, different volume might be in sample location 120₂.

The first optical coupling arrangement 114ₙ includes at least one lens, which collimates light 121ₙ output from the input optical fiber 108ₙ. The collimated light 122ₙ travels through the sample location 120ₙ and to the second optical coupling arrangement 118ₙ. The second optical coupling arrangement 118ₙ also includes at least one lens and focuses 123ₙ the collimated light 122ₙ into the output optical fiber 116ₙ. The diameter of the collimated light 122ₙ and the dimensions of the sample vessel are sized so that substantially all of the collimated light 122ₙ traveling between the first and second optical coupling arrangements 114ₙ and 118ₙ travels through the sample vessel and through the sample contained in the sample vessel. A possible embodiment for the first and second optical coupling arrangements 114ₙ and 118ₙ is disclosed in more detail within U.S. patent application Ser. No. 10/963,865, filed on Oct. 12, 2004, the entire disclosure of which is hereby incorporated by reference.

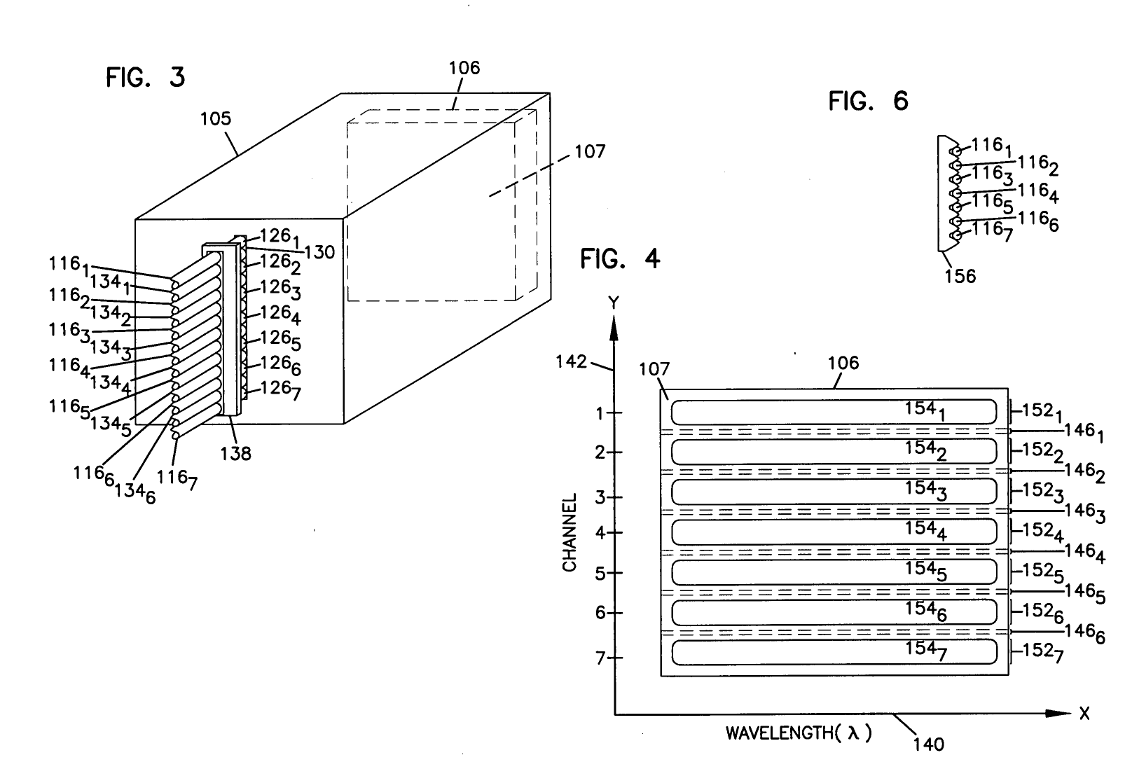

FIGS. 3 and 4 illustrate an exemplary embodiment of the spectrometer 105 configured to receive input from seven signal paths or channels 104₁-104₇, although other embodiments can receive inputs from more or less than seven signal paths 104₁-104₇. The spectrometer 105 includes an elongated input slit 130 and a detector 106. One will appreciate that the spectrometer 105 also includes internal components (not shown) for processing the light traveling between the input slit 130 and the detector 106. Examples of such internal components include diffraction gratings, collimating mirrors or lenses, other mirrors or lenses, prisms, and the like. As with conventional spectrometers, the internal components process light traveling between the entrance slit 130 and the detector 106 to disperse the light into its component wavelengths and image it onto the detector plane.

The second end 126ₙ of the output optical fiber 116ₙ is positioned proximal to and opposing the input slit 130 of the spectrometer 105 so that light output from the output optical fiber 116ₙ travels through the input slit 130 and to a detector 106, which resides at the imaging plane 107 for the spectrometer 105. The width of the input slit 130 is chosen to obtain the desired wavelength resolution of the spectrometer 105, and the spectrometer input numerical aperture is chosen to match the numerical aperture of the fiber 116ₙ.

The detector 106 is a two-dimensional photo-detector array (2D-PDA) that has rows of light sensitive photo-detectors that are sensitive to the part of the spectrum (i.e., light wavelengths) used to analyze various compounds of interest. An example of a detector 106 includes a charge-coupled device (CCD) having rows of photodiodes formed in a semiconductor material such as a complimentary metal-oxide semiconductor (CMOS). One possible detector 106 is a two-dimensional charge coupled device (CCD) such as the S8667-1010 2D-CCD detector, which is commercially available from Hamamatsu Corp. of Bridgewater, N.J.

The imaging plane 107 of the detector 106 defines a Cartesian coordinate system having an x-axis 140 and a y-axis 142. The light-sensitive photo-detectors in each row form the first dimension of the photo-detector array and extend along the x-axis 140. The x-axis 140 corresponds to the wavelength of light in the spectra detected by the light-sensitive photo-detectors in the row.

Additionally, the second end 126₁-126ₙ of the output optical fibers 116₁-116ₙ are arranged in a one-dimensional array that is substantially parallel to and opposing the input slit 130. The array of fiber ends 126₁-126ₙ and the input slit 130 extend along the y-axis 142 so that they are orthogonal to the rows of photo-detectors in the detector 106.

The rows form the second dimension of the array and are arranged along the y-axis 142. The spectrometer 105 projects light received from each separate signal path or channel 104₁-104₇ onto separate groups 152₁-152₇ of light-sensitive photo-detector rows in the detector 106. The y-axis 142 corresponds to the signal path channels 104₁-104₇. In this embodiment, the detector 106 simultaneously images spectra 154₁-154ₙ (i.e., light at a particular wavelength) received from each of the sample locations 120₁-120ₙ, respectively, and thereby simultaneously detects and records the intensity of light as a function of wavelengths for light that is received from all n-samples.

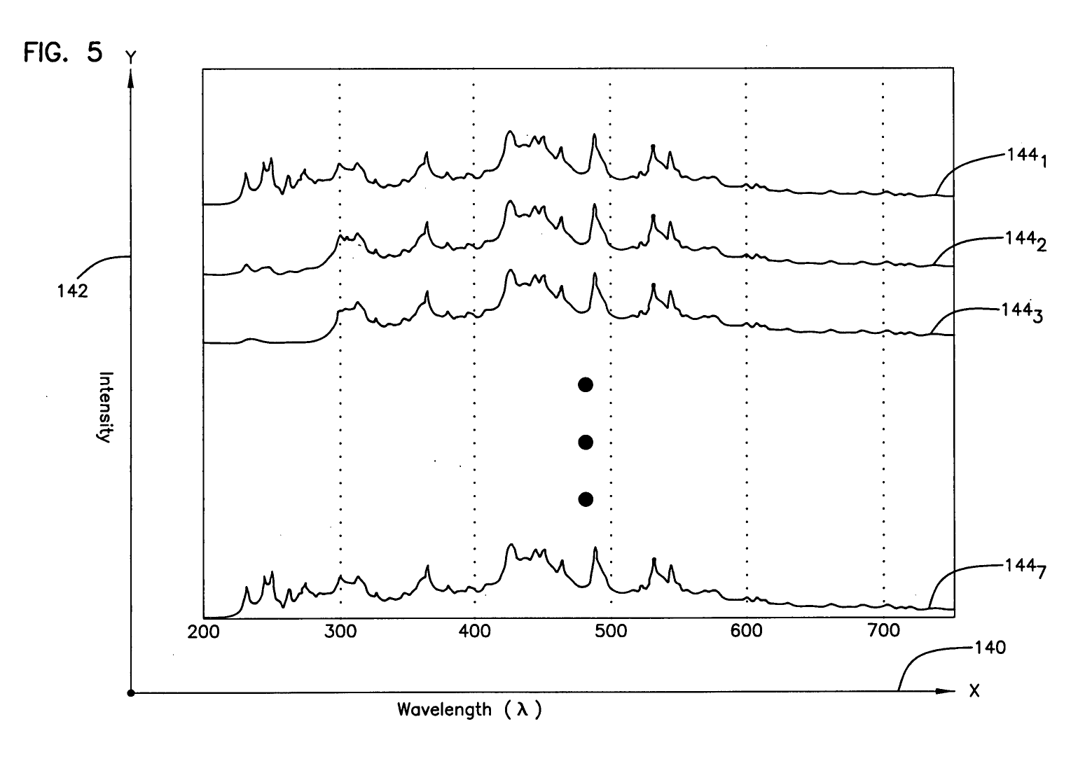

The detector 106 outputs image data representative of the light intensity as a function of wavelength for each imaged spectra 154₁-154ₙ and hence each separate light signal output from the output optical fibers 161₁-116ₙ. The output data is processed by a data acquisition device, which is a device that gathers, displays, and records the image data. FIG. 5 illustrates an example of the output from the detector 106 and the data acquisition device. In this example, output from the first output optical fiber 116₁ is illustrated as a plot of wavelength versus light intensity for light detected from each signal path or channel 104₁-104₇. Outputs from other output optical fibers 116₁-116ₙ are illustrated as plots 144₁-144ₙ.

Returning to FIGS. 3 and 4, adjacent second ends 126₁-126₇ of the output fibers 116₁-116ₙ in the exemplary embodiment are spaced to eliminate or reduce cross talk between light output from the signal bearing fibers 118₁-118₇. In this embodiment, there are one or more rows 146ₓ of light-sensitive photo-detectors that are not exposed to light positioned between each adjacent group 152₁-152₇ of light-sensitive photo-detector rows that received light from one of the signal channels or paths 104₁-104₇. In another possible embodiment, there is no dead spot 146ₓ between adjacent sets of light-sensitive transducer rows that image the diffracted light. In yet another embodiment, there is some cross talk between adjacent diffracted light signals, although it is desirable to minimize such cross talk.

The second ends 126₁-126₇ of the output optical fibers 116₁-116₇ are secured in place by a bracket 138. In the exemplary embodiment, one or more spacer fibers 134ₓ are inserted between adjacent signal bearing output fibers 116₁-116₇ to provide accurate spacing between the adjacent signal bearing output fibers 116₁-116₇. At least one end of each the spacer fiber 134ₓ is opaquely sealed so that no light will pass from the spacer fiber 134ₓ into the spectrometer 105. In an alternative embodiment, as illustrated in FIG. 6, a bracket 156 a series of v-shaped grooves 158ₙ forming a saw-tooth pattern. Each signal-bearing output fiber 116₁-116₇ is positioned in a v-shaped groove 158ₙ with center-to-center spacing between adjacent fibers 161₁-116₇ chosen to minimize cross talk between adjacent fibers 116₁-116₇. The v-shaped grooves 158ₙ locate and space the fibers 116ₙ without the need for spacer fibers 134ₓ.

Many other possible embodiments are possible. In other embodiments, for example, there are only two light paths 104₁ and 104₂ having two samples locations 120₁ and 120₂, respectively. In this embodiment, one sample location 120₁ contains the sample to be examined and the second sample location 120₂ contains a reference sample that is used to normalize the signal from the first light path. In this embodiment, the second end 126₁ of the first output optical fiber 116₁ is adjacent to a first slit, and the second end 126₂ of the second output optical fiber 116₂ is adjacent to a second slit. The second ends 126₁ and 126₂ of the output optical fibers 116₁ and 116₂ are equidistant from the x-axis. A one-dimensional photo-detector array (1D-PDA) is used to record images from the spectra output from the two output optical fibers 116₁ and 116₂, with one image formed on one half of the 1D-PDA and the other image formed on the other half of the 1D-PDA. An example of a spectrometer with a 1D-PDA capable of simultaneously recording two images is the model MD5 spectrometer manufactured by Headwall Photonics, Inc. of Fitchburg, Mass.

The various embodiments described above are provided by way of illustration only and should not be construed to limit the following claims. Those skilled in the art will readily recognize various modifications and changes that may be made without following the example embodiments and applications illustrated and described herein, and without departing from the true spirit and scope of the disclosure and the following claims.

The claims are:

1. A photometer for analyzing a plurality of samples, comprising:
a light source;
a detector; and
an optical assembly defining two or more light paths, each light path arranged to carry light from the light source, through a separate sample location, and to the detector.

2. The photometer of claim 1 wherein:
for each separate sample location, the optical assembly includes at least one optical fiber arranged between the light source and the separate sample location.

3. The photometer of claim 2 wherein:
for each separate sample location, the optical assembly includes at least one lens positioned between the optical fiber and the sample location, the at least one lens configured to substantially collimate light radiated from the optical fiber.

4. The photometer of claim 1 wherein:
for each separate sample location, the optical assembly includes at least one optical fiber arranged between the separate sample location and the detector.

5. The photometer of claim 4 wherein each optical fiber arranged between one of the separate sample locations and the detector has a first end positioned to receive light from its respective separate sample location and a second end positioned to direct light onto the detector.

6. The photometer of claim 4 wherein:
each optical fiber arranged between one of the separate sample locations and the detector has a first end positioned to receive light from its respective sample location and a second end positioned to direct light to the detector; and
the second end of the optical fibers arranged between one of the separate sample locations and the detector are spaced to substantially eliminate crosstalk between light directed from the second end of the optical fibers to the detector.

7. The photometer of claim 1 wherein the detector is a charge-coupled device.

8. The photometer of claim 1 further comprising:
at least one sample vessel positioned in at least one of the sample locations.

9. The photometer of claim 8 wherein the sample vessel is a Cuvette having a volume of about 5 μl or less.

10. A photometer for analyzing a plurality of samples, comprising:
a light source;
a two dimensional photo-detector array (2D-PDA); and
an optical assembly defining two or more light paths, each light path including:
at least one input optical fiber arranged between the light source and a sample location;
a lens positioned between the input optical fiber and the sample location, the lens configured to substantially collimate light radiated from the input optical fiber; and
at least one output optical fiber arranged between the sample location and the 2D-PDA, the output optical fiber having a first end positioned to receive light passing through the sample location and a second end positioned to direct light to the 2D-PDA, the second end being positioned to substantially eliminate crosstalk between light directed to the 2D-PDA from the two or more light paths.

11. A method of analyzing a plurality of samples, the method comprising:
conducting light along two or more light paths;
passing the light from each of the two or more light paths through a separate sample; and
conducting the light from each of the separate samples to a detector.

12. The method of claim 11 wherein, for each separate sample, at least one optical fiber extends from a light source to the separate sample, and the act of conducting light along two or more light paths includes:
conducting light along at least one optical fiber from the light source to one sample; and
conducting light along at least another optical fiber from the light source to another sample.

13. The method of claim 11 wherein for each separate sample at least one optical fiber forms a light path from a light source to the sample and at least one optical fiber forms a light path from the sample to the detector, and act of passing the light from each of the two or more light paths through a separate sample includes:
substantially collimating the light radiated from the input optical fiber; and
passing the substantially collimated light through the sample.

14. The method of claim 13 wherein each sample is in a Cuvette having a volume of about 5 μl or less, and the act of passing the substantially collimated light through a sample vessel includes:
passing substantially all of the substantially collimated light through the sample.

15. The method of claim 11 wherein, for each separate sample location, at lease one optical fiber is arranged to conduct light from the separate sample to the detector, and the act of conducting light from each of the separate samples to a detector includes:
conducting light along at least one optical fiber from one sample to the detector; and
conducting light along at least another optical fiber from another sample to the detector.

16. The method of claim 15 wherein the act of conducting light from each of the separate samples to a detector includes:
simultaneously projecting the light received from each of the separate samples onto the detector.

17. The method of claim 16 wherein the act of simultaneously projecting the light received from each of the separate samples onto the detector includes:
simultaneously projecting the diffracted light onto a charge-coupled device.

18. The method of claim 16 wherein the act of simultaneously projecting the light from each of the separate samples onto the detector includes:
simultaneously projecting the diffracted light onto the detector without crosstalk between light passed through each of the separate samples.
